(19) United States
(12) Patent Application Publication
(10) Pub. No.: US 2022/0259470 A1
(43) Pub. Date: Aug. 18, 2022

(54) COMPOSITIONS FOR AN INSULATION TAPE

(71) Applicant: Hexion Inc., Columbus, OH (US)

(72) Inventors: Thomas DRESSEN, Oberhausen (DE); Christoph Scheuer, Dinslaken (DE); Gunda Kuhlmann, Hamm (DE); Panagiotis Saltapidas, Datteln (DE)

(21) Appl. No.: 17/720,066

(22) Filed: Apr. 13, 2022

Related U.S. Application Data
(62) Division of application No. 16/465,080, filed on Jun. 3, 2019.

(30) Foreign Application Priority Data
Nov. 30, 2016 (DE) 102016014267.7

(51) Int. Cl. C09J 161/14; C09J 11/08; H01B 3/36; H02K 3/30; H02K 3/40; C09J 161/06; C08K 5/17; C08K 3/16; C08K 5/3445; C08L 61/06

(52) U.S. Cl. CPC C09J 161/14; C09J 11/08; H01B 3/36; H02K 3/30; H02K 3/40; C08K 3/34; C08K 5/17; C08K 3/16; C08K 5/3445; C08L 61/06; C09J 161/06

(57) ABSTRACT

Compositions for fixing a non-conductive material to a reinforcing layer are provided. In one embodiment, the composition being used to fix a non-conductive material on a reinforcing layer including a novolac produced by condensation of a substituted or unsubstituted phenol with an aldehyde in the presence of a catalyst, and optionally other additives.

The present invention relates to a composition for the production of an insulation tape, where the composition serves for the fixing of a nonconductive material on a reinforcement layer, and to use thereof.

The insulation system in high-voltage devices, e.g. motors or generators, serves to provide durable electrical insulation of electrically conductive constituents such as wires, coils or bars, in relation to one another and in relation to the laminated stator core or the environment. A problem generally arising in these insulation systems is the occurrence of partial discharges due to cumulative charge migrations, the final result of which can be electrical breakdown of the insulator. In order to counter this problem, mica tapes are wound around the parts requiring insulation, and are intended to maintain the function of the conductor in the event of fire. Production of a mica tape involves use of an adhesive for adhesive bonding of a mica paper, frequently produced from a mica pulp (comprising muscovite and phlogopite) with use of a binder, to a strong backing tape, an example being woven fabric, nonwoven fabric or foil made of, for example, glass, rockwool, polyester or polyimide. The mica paper can have the backing tape on one side or on both sides, and the sides here can also consist of different backing materials. In the adhesive-bonding method used, the adhesive is used to penetrate the mica paper and the backing material, and a prepreg is thus formed.

Adhesives used are resin compositions which have high strength at room temperature in order to ensure bonding of mica and backing, and which become liquid at elevated temperatures (from 60° C. to 150° C.). This ensures that they can be applied in the form of liquid adhesive at elevated temperature or in a mixture with a volatile solvent. After cooling or removal of the solvent, the adhesive is strong but nevertheless flexible, thus permitting secure winding of the mica tape around the conductive part at room temperature, while its adhesive properties prevent delamination of the mica paper from the backing material. The prior art (WO 1998/014959 A1) discloses the following inter alia as resin component of the adhesive: silicone resins, polyalkylenes, polyvinyl esters, polyvinyl alcohols. However, epoxy resins are particularly suitable for this purpose because of their conductivity parameters: U.S. Pat. Nos. 5,618,891, 5,158,826, 4,656,090, 3,647,611, and also WO 2015/062660 A1 describe specific epoxy resin compositions for mica tapes. The adhesive generally moreover comprises, in addition to the epoxy resin component, an accelerator component that is suitable for initiating the hardening process of the subsequently applied impregnation resin based on epoxy resin (e.g. anhydride curing), but only specifically selected accelerators have been suitable for this purpose, because it is essential to avoid premature hardening on the mica tape, for example during storage of the mica tape or during the impregnation process.

The conductor around which mica tape has been wound is generally preferably impregnated with synthetic resin in a vacuum-pressure-impregnation process (VPI process).

In a first step of the vacuum-pressure-impregnation process, vacuum is used to evaporate the residual moisture from the conductor around which mica tape has been wound and which requires impregnation, and which is located in the impregnation vessel, and in a following second step said windings are flooded with an impregnation resin from a feed vessel, initially at reduced pressure and then under increased pressure. Complete penetration of the insulation systems can thus be achieved. The resin uptake of the insulation system can be monitored by means of capacitance measurement. The process has ended when the capacitance change has reached a minimum. The pressure prevailing in the vessel can be used to force the impregnation resin back into the feed vessel. After drip-drying, the product is transferred to the drying oven, where hardening takes place. Resins used as impregnation resin are mainly those based on epoxy resin, because these do not require additional solvents. These resins moreover have good vacuum resistance, low volume shrinkage, and high adhesive bond strength in relation to the mica tape. In order that the viscosity of the epoxy resin is appropriate for the process, it is kept at temperatures of from 60° C. to 70° C. in the impregnation vessel. That requires a hardener—which is in a mixture with the epoxy resin component in the impregnation vessel—which is not reactive at said temperatures but is reactive only at significantly higher temperatures of the hardening process (>120° C.). The hardener must moreover also ensure that the impregnation cycle is short and that loss due to drip-off after the impregnation procedure is small. Compounds therefore suitable as hardeners for the epoxy-resin-based impregnation resin are carboxylic anhydrides, e.g. hexahydrophthalic anhydride (HHPA) and methylhexahydrophthalic anhydride (MHHPA), which however are suspected of being hazardous to health, and should therefore be excluded from the production process.

It is therefore an object of the present invention to provide an insulation tape—preferably mica tape—that, in particular when used in the production of the insulation for medium- and high-voltage devices in the VPI process, avoids use of conventional hardeners, in particular carboxylic anhydrides.

Said object is achieved in the invention via a composition for the production of an insulation tape, where the composition serves for the fixing of a nonconductive material on a reinforcement layer, characterized in that the composition comprises
a) a novolac produced by condensation of a substituted or unsubstituted phenol with an aldehyde, where the molar mass of the novolac is from 250 to 1000 g/mol, and
b) a catalyst selected from the group of the boron(III) halides and/or amine complexes thereof, imidazoles, acetylacetonates, tin(IV) chloride and/or tertiary amines and/or tetramethylguanidine, and
c) optionally other additives.

The composition of the invention is applied in conventional manner by means of spreading or doctoring, or through nozzles, to the reinforcement layer, i.e. the backing tape, preferably composed of a woven fabric, knitted fabric, nonwoven fabric or foil made of glass and/or rockwool and/or polyimide and/or polyester and/or quartz, as adhesive between the nonconductive material, preferably mica. This gives a composite made of mica paper coated with reinforcement layers on one or more sides and impregnated over its entire area by the composition of the invention. The insulation tape preferably comprises from 5 to 20% by weight of the adhesive of the invention, based on the entirety (backing tape, nonconductive material, adhesive).

By virtue of the careful selection of the components and of the resultant reactivity of the composition of the invention, said composite is stable in storage at room temperature, and can optionally be cut to size to give a desired tape width and stored as rolls of product. It is now possible to provide mica tapes with better stability in storage than the mica tapes described above based on epoxy resin with a catalyst component that initiates subsequent anhydride curing.

The mica tape comprising the composition of the invention can in particular be used to provide insulation for medium- and high-voltage devices which comprise epoxy resins as impregnation resin and advantageously are produced by the VPI process. During the impregnation procedure, the conductor around which mica tape has been wound is impregnated, by means of vacuum, by the impregnation resin which is based on epoxy resin and has been heated (at about 40-80° C.), where the mica tape comprises the composition of the invention. The novolac of the composition of the invention is introduced by way of the mica tape into the epoxy resin of the impregnation resin, and acts as co-hardener for the latter. The catalyst present in the mica tape serves to initiate the homopolymerization of the impregnation resin and to accelerate the curing procedure of all of the impregnated layers; it was thus possible to optimize the hardening time.

By virtue of the inventive composition of the mica tape, it was possible to keep the loss factor tan(δ) of the insulation layer, which states the loss of electrical energy resulting from conversion into heat, at an appropriate level, thus permitting achievement of adequate insulation properties. By virtue of the use of the composition of the invention in the mica tape, it was possible to omit use, in the epoxy impregnation resin, of anhydride hardeners that were hitherto conventional; this is desirable for reasons related to health and to the environment.

The novolacs used for the insulation-tape composition of the invention are known from the prior art. They are produced by condensation of a substituted or unsubstituted phenol with an aldehyde, where the molar mass of the resultant novolac is from 250 to 1000 g/mol (measured in accordance with DIN 55672-1): it is preferable that monocyclic substituted or unsubstituted phenols (e.g. phenol, cresols and/or p-tert-butylphenol) are reacted with aldehydes (preferably formaldehyde) under acidic conditions. These compounds are readily available. The catalysts most frequently used for the acidic condensation are oxalic acid, hydrochloric acid, p-toluenesulfonic acid, phosphoric acid and sulfuric acid. Typical molar ratios in the reaction mixture here are from 0.75 to 0.85 mol of formaldehyde to 1 mole of phenol (F/P=from 0.75 to 0.85). The condensation is terminated when a molar mass of from 250 to 1000 g/mol, preferably from 250 to 500 g/mol, has been reached, because it is thus possible to adjust the viscosity of the composition, which plays an important part in application to the backing tape, to an ideal value.

The novolacs used in the invention are obtainable commercially by way of example as Bakelite® PH 8505 (product of Hexion GmbH).

The composition of the invention moreover comprises a catalyst, preferably from 1 to 30% by weight, more preferably from 5 to 30% by weight, based on the entire novolac, selected from the group of the boron(III) halides and/or amine complexes thereof, imidazoles, acetylacetonates, tin(IV) chloride and/or tertiary amines and/or tetramethylguanidine. Preference is given to boron trifluoride complexes and boron trichloride complexes, and also amine borates, but particular preference is given to compounds from the group of the imidazoles, in particular 2-phenylimidazole. A requirement deriving from the process is that the catalyst present in the mica tape has an appropriate vapor pressure which on the one hand does not result in evolution of gas after the final processing of the mica tape and on the other hand allows migration during the VPI process into the layers saturated by the impregnation resin in order to accelerate thorough curing of the impregnated layers. This is ensured via careful selection of the catalysts.

The composition of the invention can optionally comprise, as further constituent, other additives such as processing aids (e.g. solvents, e.g. methyl ethyl ketone), coupling agents (e.g. silanes), or wetting agents. These additives have a favorable effect on the production and properties of the insulation tape.

The composition therefore advantageously comprises by way of example from 50 to 90% by weight of novolac, from 1 to 30% by weight of catalyst and from 0 to 49% by weight of other additives, based on the entirety of all of the components of the composition.

Production of insulation for a conductor requiring insulation is achieved by a process comprising the following steps:
(I) provision of an insulation tape which comprises a nonconductive material and a reinforcement layer adhesive-bonded to one another by means of a composition, where the composition comprises
   a) a novolac produced by condensation of a substituted or unsubstituted phenol with an aldehyde, where the molar mass of the novolac is from 250 to 1000 g/mol, and
   b) a catalyst selected from the group of the boron(III) halides and/or amine complexes thereof, imidazoles, acetylacetonates, tin(IV) chloride and/or tertiary amines and/or tetramethylguanidine, and
   c) optionally other additives,
(II) winding of the insulation tape around the electrical conductor and
(III) use of a resin based on epoxy resin to impregnate the insulation tape wound around the conductor.

The impregnation resin based on epoxy resin is known from the prior art: the resin can be selected from the group of the polyepoxides based on bisphenol A and/or F and of advancement resins produced therefrom, based on epoxidized halogenated bisphenols and/or on epoxidized novolacs, and/or polyepoxyester based on phthalic acid or hexahydrophthalic acid, or based on terephthalic acid, or of epoxidized o- or p-aminophenols, or epoxidized polyaddition products made of dicyclopentadiene and phenol.

Examples of materials used as resin components are therefore epoxidized phenol novolacs (condensate of phenol and, for example, formaldehyde and/or glyoxal), epoxidized cresol novolacs, bisphenol-A-based polyepoxides (including, for example, product of bisphenol A and tetraglycidylmethylenediamine), epoxidized halogenated bisphenols (e.g. tetrabromobisphenol-A-based polyepoxides) and/or bisphenol-F-based polyepoxides, and/or epoxidized novolac and/or epoxy resins based on triglycidyl isocyanurates. The average molar mass of all of these resins is preferably from 200 to 4000 g/mol, and the epoxy equivalent is preferably from 100 to 2000 g/eq.

Examples of resin components that can be used are inter alia the following: polyepoxides based on bisphenol A (e.g. Epikote® 162 or 828) and/or bisphenol F (e.g. Epikote® 158 or 862), and also mixtures thereof, and cycloaliphatic epoxy resins (e.g. Epikote® 760 products obtainable from Hexion Inc.), and mixtures comprising reactive diluents (e.g. Heloxy® Modifier AQ).

The impregnation resin can also optionally comprise other components, e.g. wetting agents, which serve to control surface tension. It would also be possible to add other constituents having curing action, but it is preferable here to avoid use of anhydrides in the impregnation resin.

The impregnation in step (III) particularly preferably takes place in vacuo (VPI process), thus ensuring that the impregnation resin achieves almost complete impregnation of the composite made of the conductor around which, mica tape has been wound. The impregnation procedure is generally followed by hardening in a drying oven in the temperature range from 80° C. to 180° C., as required by the impregnation resin used.

The invention will be explained in more detail with reference to an embodiment:

1. Production of the Mica Tape
The adhesive component for production of the mica tape is first formulated as follows:
1000 g of the novolac (Bakelite® PH 8505) is heated to 60° C. and 150 g of 2-phenylimidazole are admixed therewith.
The mixture is homogenized at 60° C. within a period of one hour. An 80% solution in methyl ethyl ketone is then produced at 60° C. and cooled to room temperature. The resultant adhesive is used to fix a layer of mica paper, thickness 100 μm, on a nonwoven glass fabric with layer weight 23 g/m². To this end, 20 g/m² of the adhesive are sprayed onto the nonwoven glass fabric and bonded to the mica paper, and the composite is dried at 70° C. in vacuo (10 mbar).
The resultant mica tape is cooled to room temperature.

2. Production of the Impregnation System in the VPI Process
The mica tape produced as described above is cut to size to give sheets measuring 10×10 cm. Ten layers of the mica tape are placed in layers on top of one another to give a total layer thickness of about 2 mm and, at 40° C. and 5 mbar in a metal mold with two open sides, impregnated with an impregnation resin consisting of 250 g of EPIKOTE™ Resin 162, 750 g of EPIKOTE™ Resin 158 and 150 g of Heloxy™ Modifier AQ within a period of 60 minutes. A gauge pressure of 6 bar is used for continued impregnation for a further 60 minutes.
The excess impregnation resin is discharged, and the metal mold is transferred to a curing oven. Curing takes place in two stages, firstly 3 hours at 90° C. and then 15 hours at 140° C.

3. Insulation Properties
The composite made of impregnation resin and adhesive leads to the following temperature-dependent loss factors (tan(δ)) after curing:

| Temp. in ° C. | tan(δ) |
|---|---|
| 25 | 0.005 |
| 50 | 0.00715 |
| 75 | 0.0104 |
| 100 | 0.017 |
| 120 | 0.0522 |
| 140 | 0.2425 |
| 180 | 1.206 |

These are at a level comparable with those comprising anhydride hardeners in the impregnation resin, and the impregnation system of the invention therefore also provides the desired insulation properties.

What is claimed is:

1. An article of manufacture, comprising:
a reinforcement layer;
an adhesive composition disposed on the reinforcement layer, the adhesive composition comprising:
a) a novolac produced by condensation of a substituted or unsubstituted phenol with an aldehyde, where the molar mass of the novolac is from 250 to 1000 g/mol;
b) a catalyst selected from the group consisting of boron(III) halides and/or amine complexes thereof, imidazoles, acetylacetonates, tin(IV) chloride, tertiary amines, tetramethylguanidine, and combinations thereof; and
c) optionally other additives; and
a nonconductive material disposed on the reinforcement layer and the adhesive composition.

2. The article of claim 1, wherein the composition comprises from 50 to 90% by weight of novolac, from 1 to 30% by weight of catalyst and from 0 to 49% by weight of other additives based on the entirety of all of the components of the composition.

3. The article of claim 1, wherein the composition comprises from 5 to 30% by weight of catalyst based on the weight of the novolac.

4. The article of claim 1, wherein the novolac has been produced by condensation of phenol and/or cresol with formaldehyde.

5. The article of claim 1, wherein the molar mass of the novolac is from 250 to 500 g/mol.

6. The article of claim 1, wherein the catalyst comprises an imidazole.

7. The article of claim 1, wherein the nonconductive material comprises mica.

8. The article of claim 1, wherein the reinforcement layer comprises a woven fabric, a knitted fabric, a nonwoven fabric or foil made of glass, rockwool, polyimide, polyester, or a combination thereof, and combinations thereof.

9. The article of claim 1, wherein the article comprises from 5% to 20% by weight of the adhesive.

10. The article of claim 1, wherein the article further comprises an electrical conductor.

11. The article of claim 10, wherein the article further comprises a resin based on epoxy resin.

12. The article of claim 10, wherein the resin based on epoxy resin impregnates the article.

13. The article of claim 1, wherein the article comprises a tape.

14. The article of claim 13, wherein the article comprises a mica tape.

15. The article of claim 10, wherein the electrical conductor comprises a medium-voltage devices, a high-voltage device, or both.

16. A process comprising:
(I) providing an insulation tape comprising a nonconductive material and a reinforcement layer adhesive-bonded to one another by means of a composition, wherein the composition comprises:
a) a novolac produced by condensation of a substituted or unsubstituted phenol with an aldehyde, where the molar mass of the novolac is from 250 to 1000 g/mol;
b) a catalyst selected from the group consisting of boron(III) halides and/or amine complexes thereof, imidazoles, acetylacetonates, tin(IV) chloride, tertiary amines, tetramethylguanidine, and combinations thereof; and
c) optionally other additives;
(II) winding the insulation tape around an electrical conductor; and
(III) impregnating the insulation tape wound around the conductor with a resin based on epoxy resin.
